(19) United States
(12) Patent Application Publication
(10) Pub. No.: US 2008/0289493 A1
(43) Pub. Date: Nov. 27, 2008

(54) ADVANCED METHANE AND AMMONIA RECOVERY SYSTEM

(76) Inventor: SAL CARO, Camarillo, CA (US)

Correspondence Address: AVERILL & VARN, 8244 PAINTER AVE., WHITTIER, CA, 90602, US

(21) Appl. No.: 11/754,057

(22) Filed: May 25, 2007

(51) Int. Cl. B01D 45/00; B01D 46/46

(52) U.S. Cl. 95/23; 55/437; 96/422

(57) ABSTRACT

An advanced methane and ammonia recovery system processes gaseous waste from domestic livestock and poultry farms to reduce the green house gasses which are presently dumped into the environment and to produce useful material. The system includes a gas recovery system. The methane and ammonia recovery system captures ammonia and methane and converts the ammonia into fertilizer and methane into energy. The system is designed to substantially reduce the amount of green house gases introduced into the environment, while providing additional income to the domestic livestock and poultry farms

### BACKGROUND OF THE INVENTION

The present invention relates to processing treatment of waste from domestic livestock and poultry operations and in particular to an integrated system for efficiently processing waste material from domestic livestock and poultry operations.

Domestic livestock and poultry operations in the United States produce a substantial portion of the food regularly consumed by the pubic. Unfortunately, these operations also produce significant waste which must be dealt with, and significant odors not appreciated by local residents. Until the present time, no large scale systems have been developed to deal efficiently with green house gas created in the form of methane.

### BRIEF SUMMARY OF THE INVENTION

The present invention addresses the above and other needs by providing an advanced methane and ammonia recovery system which processes gaseous waste from domestic livestock and poultry farms to reduce the green house gasses which are presently dumped into the environment and to produce useful material. The system includes a gas recovery system. The methane and ammonia recovery system captures ammonia and methane and converts the ammonia into fertilizer and methane into energy. The system is designed to substantially reduce the amount of green house gases introduced into the environment, while providing additional income to the domestic livestock and poultry farms.

In accordance with one aspect of the invention, there is provided a gas recovery system including a barn, a gas capture vessel, an ammonia/methane separator, a compressor/chiller and membrane unit, and a methane storage tank. The gas capture vessel has a height between approximately 20 feet and approximately 25 feet and a diameter between approximately eight feet and approximately ten feet, and resides at a peak of the barn for collecting gaseous waste. A first methane sensor resides inside the gas capture vessel between approximately two feet and approximately four feet below a top of the gas capture vessel and a second methane sensor resides inside the gas capture vessel vertically between approximately 2.5 feet and approximately four feet above a bottom of the gas capture vessel. A first ducting fluidly connects the gas capture vessel to the ammonia/methane separator and a second ducting fluidly connects the ammonia/methane separator and the compressor/chiller and membrane unit. A fan resides in the flow between the ammonia/methane separator and the compressor/chiller and membrane unit and controlled by the first methane sensor and the second methane sensor. A third ducting fluidly connects the compressor/chiller and membrane unit to the methane storage tank for carrying methane from the compressor/chiller membrane unit to the methane storage tank. The compressor/chiller and membrane unit separates methane gas from other gasses and the methane gas stored in the methane storage tank may be used to power a generator.

In accordance with another aspect of the invention, there is provided a method for controlling a gas recovery system. The method includes the steps of initially turning to OFF a fan used to draw gaseous waste from a gas capture vessel through the gas recovery system. The system then enters a loop and tests if the fan is ON or OFF. If the fan is ON and if a first gas sensor residing inside the gas capture vessel proximal to a top of the gas capture vessel is sensing the presence of the gaseous waste, the fan remains ON. If the fan is ON and if the first gas sensor is not detecting the presence of the gaseous waste, the fan is turned OFF. If the fan is OFF, leaving the fan OFF if either or both the first gas sensor is not sensing the presence of the gaseous waste and a second gas sensor residing inside the gas capture vessel proximal to a bottom of the gas capture vessel is not sensing the presence of the gaseous waste. If the fan is OFF, turning the fan ON if both gas sensors are detecting the presence of the gaseous waste.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a block diagram of a methane and ammonia recovery system according to the present invention.

FIG. 2 depicts a barn with a gas capture vessel residing at a peak, and gas processing equipment.

FIG. 3 shows a perspective view of the gas capture vessel.

FIG. 4 shows a side view of the gas capture vessel.

FIG. 5 is a cross-sectional view of the gas capture vessel taken along line 5-5 of FIG. 4.

FIG. 6 is a method according to the present invention.

FIG. 7 depicts a small barn with the gas capture vessel residing at a peak, and gas processing equipment.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

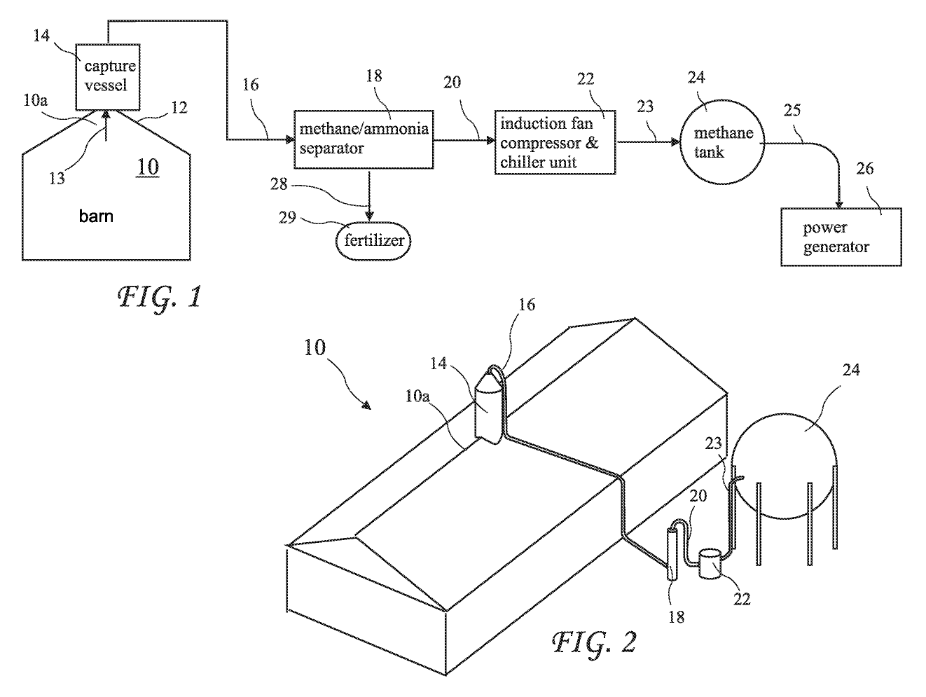

An advanced methane and ammonia recovery system according to the present invention is shown in FIG. 1. A livestock or poultry barn, house, and/or enclosure 10 produces gaseous waste 13. The gaseous waste 13 is collected by a gas capture vessel 14 residing at a peak 10a of the barn 10. The gaseous waste 13 is lighter than air and rises into the gas capture vessel 14. The gaseous waste 13 is collected in the gas capture vessel 14 and carried by first ducting 16 to an ammonia/methane separator 18 (for example, an ammonia scrubber). The ammonia/methane separator 18 separates ammonia from other gasses (primarily methane) in the gaseous waste 13. The ammonia, which is converted into ammonium sulfate, is carried by ammonia ducting 28 to an ammonium sulfate storage tank 29 for further drying into fertilizer.

The other gasses are carried by second ducting 20 to a compressor/chiller and membrane unit 22 where the methane is separated from oxygen and nitrogen. The separation is preferably done by selectively permeable membrane(s). The compressor/chiller and membrane unit 22 preferably includes a fan to draw the gaseous waste 13 from the gas capture vessel 14 to the ammonia/methane separator 18 and from the ammonia/methane separator 18 to the compressor/chiller and membrane unit 22. Methane captured by the compressor/chiller and membrane unit 22 is carried by a third ducting 23 to a methane storage tank 24.

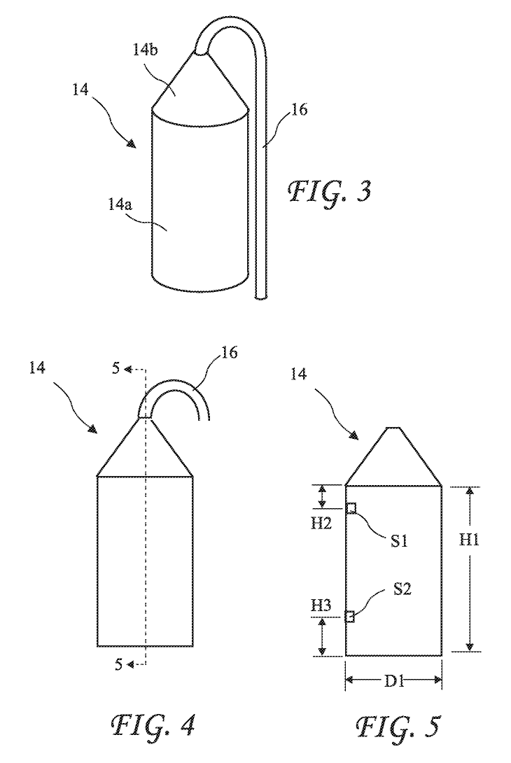

A perspective view of the gas capture vessel 14 is shown in FIG. 3, a side view of the gas capture vessel 14 is shown in FIG. 4, and a cross-sectional view of the gas capture vessel 14 taken along line 5-5 of FIG. 4 is shown in FIG. 5. The gas capture vessel 14 comprises a vertical cylindrical body 14a and a frustoconical shaped top 14b tapering to a peak where the duct 16 receives the gaseous waste 13 collected in the gas capture vessel 14.

The cylindrical body 14a has a height H1 which is preferably between approximately 20 feet and approximately 25 feet tall and a diameter D1 which is preferably between approximately eight feet and approximately ten feet, but may vary outside this range depending on the number of animals in the barn. Gas sensors S1 and S2 reside inside the cylindrical body 14a. An upper gas sensor S1 resides a second height H2 below the top of the cylindrical body 14a and a lower gas sensor S2 resides a third height H3 above the base of the cylindrical body 14a. The gas sensors are preferably methane sensors, but may sense any gas present in the gaseous waste 13 in sufficient quantities to allow reliable sensing of the presence of the gaseous waste 13 in the gas capture vessel 14. The height H2 is preferably between approximately two feet and approximately four feet depending on the number of animals in the barn. The height H3 is preferably between approximately 2.5 and approximately four feet, and is more preferably approximately four feet.

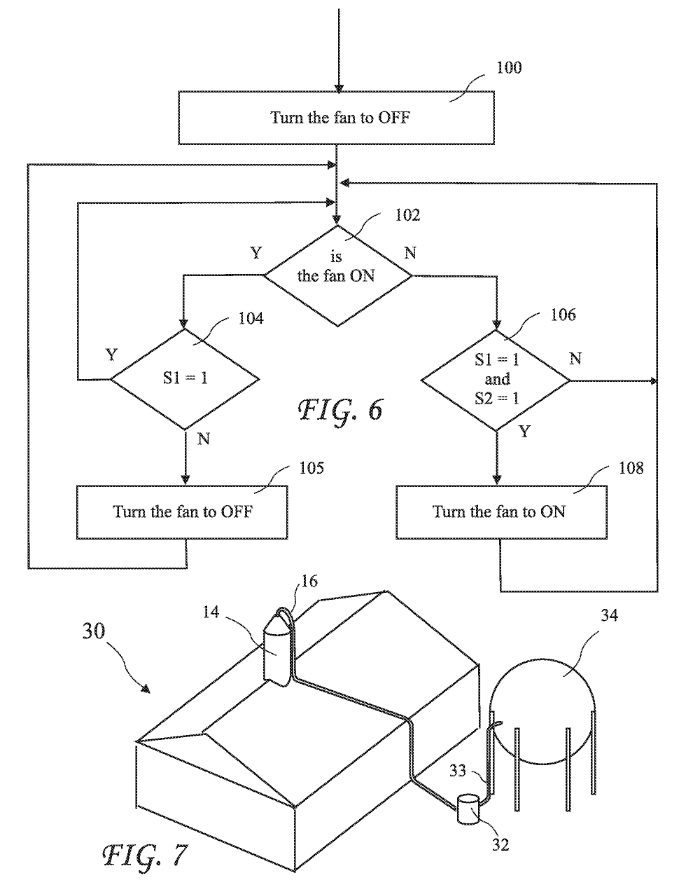

A method for controlling an operation of the gas recovery system is described in FIG. 6. The fan is initially turned to OFF at step 100 and a control loop is entered. If the fan is ON at step 102, and if the first gas senor S1 is detecting (i.e., S1=1) the presence of the gaseous waste 13, the fan remains ON. If the fan is ON at step 102, and if the first gas senor S1 is not detecting (i.e., S1=0) the presence of the gaseous waste 13, the fan is turned OFF at step 105. If the fan is OFF at step 102, and if both the first senor S1 is detecting (i.e., S1=1) the presence of the gaseous waste 13 and the second senor S2 is detecting (i.e., S2=1) the presence of the gaseous waste 13 at step 106, the fan is turned ON at step 108. If the fan is OFF at step 102, and if either or both the first senor S1 is not detecting (i.e., S1=0) the presence of the gaseous waste 13, and the second senor S2 is not detecting (i.e., S2=0) the presence of the gaseous waste 13 at step 106, the fan remains OFF. In all cases, the control loop returns to step 102.

A small barn 30 with the gas capture vessel 14 residing at a peak, and gas processing equipment is shown in FIG. 7. The gas produced in the small barn 30 may not be sufficient to make the system shown in FIGS. 1 and 2 economically feasible. As a result, a small system comprising a fan/compressor unit 32 connected to the gas capture vessel 14 by the ducting 16, and a gas storage tank 34 connected to the fan/compressor unit 32 by ducting 33, is an alternative system. The gas stored in the tank 34 is periodically collected for processing at a remote location which services small farms in the local area.

While the invention herein disclosed has been described by means of specific embodiments and applications thereof, numerous modifications and variations could be made thereto by those skilled in the art without departing from the scope of the invention set forth in the claims.

I claim:

1. A gas recovery system comprising:
a barn;
a gas capture vessel residing at a peak of the barn for collecting gaseous waste;
a gas storage tank;
a compressor for moving the gaseous waste into the storage tank; and
a controllable fan for moving the gaseous waste from the gas capture vessel to the compressor.

2. The gas recovery system of claim 1, further including a first gas sensor residing in the gas capture vessel for sensing the presence of the gaseous waste in the gas capture vessel and electrically connected to the fan and turning the fan ON and OFF.

3. The gas recovery system of claim 2, further including a second gas sensor residing inside the gas capture vessel vertically spaced apart below the first gas sensor, wherein:
the second gas sensor is for tuning the fan ON when the second gas sensor senses the presence of gaseous waste; and
the first gas sensor for turning the fan OFF when the first gas sensor does not sense the presence of the gaseous waste.

4. The gas recovery system of claim 3, wherein:
the gas capture vessel has a height between approximately 20 feet and approximately 25 feet and has a diameter between approximately eight feet and approximately ten feet;
the first gas sensor resided between approximately two feet and approximately four feet below a top of the gas capture vessel; and
the second gas sensor resided between approximately 2.5 feet and approximately four feet above a bottom of the gas capture vessel.

5. The gas recovery system of claim 2, further including:
an ammonia/methane separator receiving the gaseous waste from the gas capture vessel and separating ammonia from a flow of methane and other gasses; and
a compressor/chiller and membrane unit for receiving the flow of methane and other gases and separating the methane from the other gasses, wherein the methane is stored in the gas storage tank.

6. The gas recovery system of claim 5, further including a power generator receiving the methane stored in the gas storage tank and converting the methane to electrical power.

7. The gas recovery system of claim 3, wherein the fan resides on an intake of the compressor/chiller and membrane unit and draws the gaseous waste from the gas capture vessel, and through the ammonia/methane separator.

8. A gas recovery system comprising:
a barn;
a gas capture vessel having a height between approximately 20 feet and approximately 25 feet and having a diameter between approximately eight feet and approximately ten feet, the gas capture vessel residing at a peak of the barn for collecting gaseous waste;
a first methane sensor residing inside the gas capture vessel between approximately two feet and approximately four feet below a top of the gas capture vessel;
a second methane sensor residing inside the gas capture vessel between approximately 2.5 feet and approximately four feet above a bottom of the gas capture vessel;
an ammonia/methane separator;
a first ducting fluidly connecting the gas capture vessel and the ammonia/methane separator;
a compressor/chiller and membrane unit for separating methane gas from other gasses;
a second ducting fluidly connecting the ammonia/methane separator and the compressor/chiller and membrane unit;
a fan cooperating with the flow between the ammonia/methane separator and the compressor/chiller and membrane unit and controlled by the first methane sensor and the second methane sensor;
a methane storage tank; and
a third ducting fluidly connecting the compressor/chiller and membrane unit to the methane storage tank for carrying methane from the compressor/chiller membrane unit to the methane storage tank.

9. The gas recovery system of claim 8, further including a power generator receiving methane from the methane storage tank and converting the methane to electrical power.

10. A method for controlling a methane and ammonia recovery system, the method comprising:
turning to OFF a fan used to draw gaseous waste from a gas capture vessel through the gas recovery system;
entering a loop starting with testing if the fan is ON;
if the fan is ON, testing if a first gas sensor residing inside the gas capture vessel proximal to a top of the gas capture vessel is sensing the presence of the gaseous waste, and turning the fan to OFF if the first gas sensor is not detecting the presence of the gaseous waste;
if the fan is ON, testing if the first gas sensor is sensing the presence of the gaseous waste and leaving the fan ON if the first gas sensor is detecting the presence of the gaseous waste;
if the fan is OFF, testing if either or both the first gas sensor is not sensing the presence of the gaseous waste and a second gas sensor residing inside the gas capture vessel proximal to a bottom of the gas capture vessel is not sensing the presence of the gaseous waste and leaving the fan OFF if either or both gas sensors are not detecting the presence of the gaseous waste; and
if the fan is OFF, testing if both the first gas sensor is sensing the presence of the gaseous waste and the second gas sensor is sensing the presence of the gaseous waste and turning the fan ON if both gas sensors are detecting the presence of the gaseous waste.
